(19) United States
(12) Patent Application Publication
(10) Pub. No.: US 2010/0157519 A1
(43) Pub. Date: Jun. 24, 2010

(54) PERIPHERAL DEVICE CARRIER

(76) Inventors: Paul J. DOCZY, Austin, TX (US); Earl W. MOORE, Cypress, TX (US); Mark S. TRACY, Tomball, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/341,860

(22) Filed: Dec. 22, 2008

(51) Int. Cl. F16M 1/00

(52) U.S. Cl. 361/679.33

(57) ABSTRACT

Peripheral device carrier. At least some of the illustrative embodiments are systems including a screen portion with a display device viewable on one surface, a base portion hinged to the screen portion and having a keyboard, a peripheral device carrier mounted at least partially within an internal volume defined by the base portion, and a peripheral coupled within the carrier. The peripheral device carrier includes a top wall and a bottom wall coupled by two side walls, and the walls define a volume with a quadrilateral cross-section. The walls comprise a metallic material, and the walls are seamless along the quadrilateral cross-section.

### BACKGROUND

External pressure on a portable computer (e.g., ON the palm rest area of a notebook computer) may cause deflection of the external covering into the internal components. While some components weather deflection well, other components, such as hard drives, may be damaged by such deflection. Increased spacing between the external covering and the hard drive may address the issue, but such increased spacing increases the overall thickness of the portable computer when marketing trends are moving toward decreased design thickness.

### BRIEF DESCRIPTION OF THE DRAWINGS

For a detailed description of exemplary embodiments, reference will now be made to the accompanying drawings in which:

FIG. 1 shows a perspective view of a portable computer system in accordance with at least some embodiments;

FIG. 2 shows a perspective view of a peripheral device carrier and peripheral device in accordance with at least some embodiments;

FIG. 3 shows extrusion of a peripheral device carrier in accordance with at least some embodiments;

FIG. 4 show an elevational end-view of a peripheral device carrier in accordance with at least some embodiments;

FIG. 5 shows an elevational end-view of a peripheral device carrier in accordance with other embodiments;

FIG. 6 shows a perspective view of a portable computer system in accordance with at least some embodiments; and

FIG. 7 shows an elevational side-view of a peripheral device carrier in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Seamless” shall mean one continuous piece of material. The presence of a discontinuity of the material (e.g., a butt-weld of coplanar materials, or overlapped material with tack or continuous weld) obviates the seamless nature of structure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

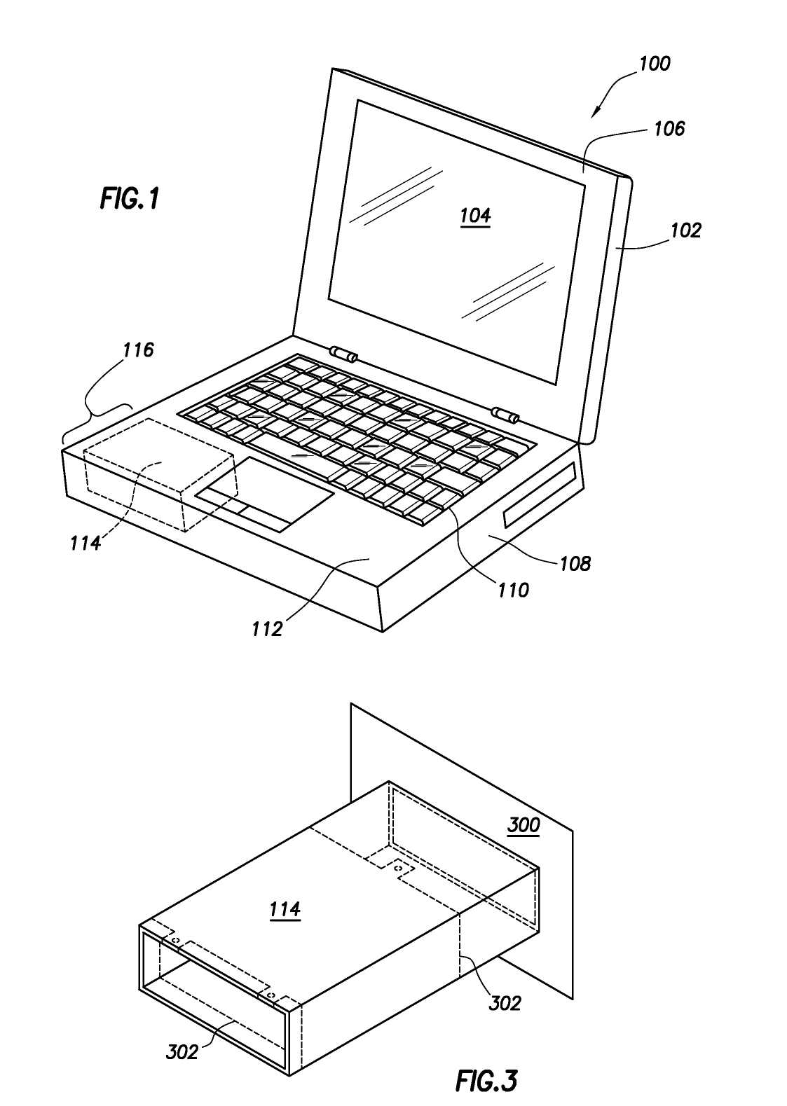

FIG. 1 shows a portable computer system 100 in the illustrative form of a notebook or laptop computer. The portable computer system 100 comprises a screen portion 102 having a display device 104 viewable on or through a surface 106 of the screen portion 102. The screen portion 102 is hinged to a base portion 108. The base portion 108 has a keyboard 110 disposed on a top surface 112 of the base portion 108. The base portion defines an internal volume within which various components of the portable computer system 100 reside, such as the motherboard. In accordance with the various embodiments, a peripheral device carrier 114 resides at least partially within the internal volume defined by the base portion 108.

The peripheral device carrier 114 is a housing within which various peripheral devices are mounted, and the peripheral device carrier 114 itself is then mounted within the internal volume defined by the base portion 108. In accordance with at least some embodiments, the peripheral device carrier 114 houses a hard disk drive, and thus the peripheral device carrier 114 may be equivalently referred to as hard drive carrier. As illustrated in FIG. 1, the peripheral device carrier 114 is, in accordance with at least some embodiments, mounted just under palm rest area 116 and within the internal volume, where the palm rest area 116 is on the upper surface 112. During use of the portable computer system 100, the base portion 108 may experience compressive forces applied by the user, particularly in the illustrative palm rest area 116, but such compressive forces may be applied at any location. In accordance with the various embodiments, the peripheral device carrier 114 is designed and constructed to reduce the risk of damage to the peripheral device held within the peripheral device carrier 114 by any such compressive forces.

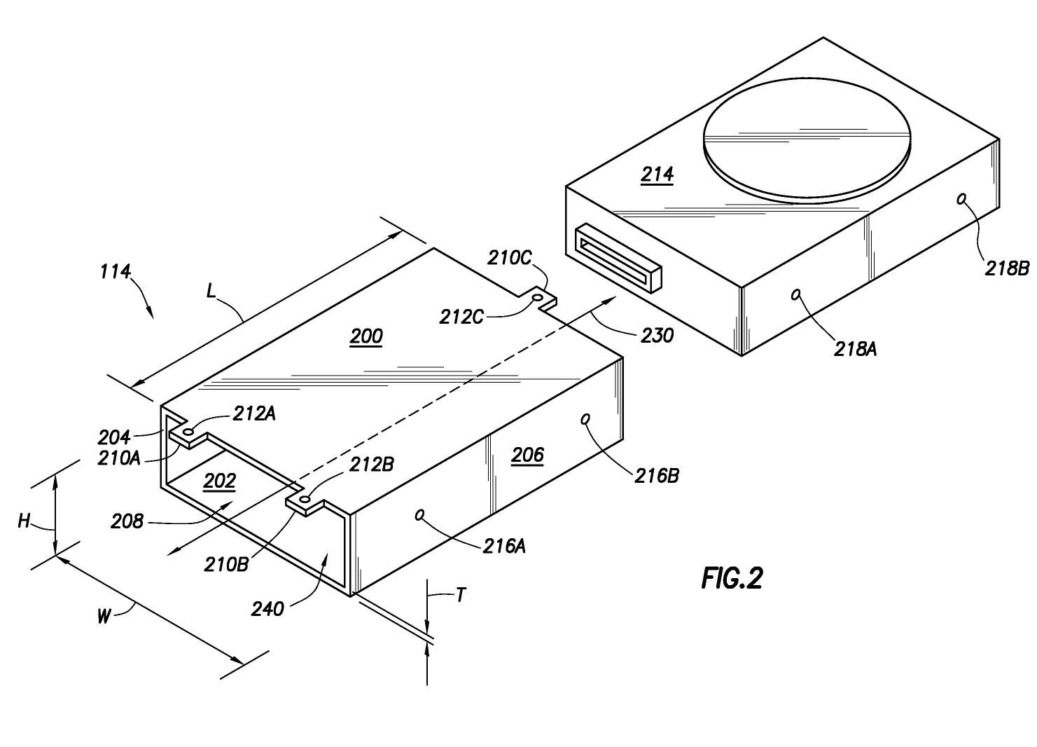

FIG. 2 shows an illustrative peripheral device carrier 114 in greater detail. In particular, the peripheral device carrier 114 has a top portion or top wall 200. The top wall defines a length “L”, a width “W”, and the top wall 200 resides within and/or defines a plane. The peripheral device carrier 114 further comprises a bottom portion or bottom wall 202 which has, in the embodiments illustrated by FIG. 2, a corresponding length L and width W. The bottom wall 202 likewise resides in and/or defines a plane, and in some embodiments the plane defined by the top wall 200 and the plane defined by the bottom wall 202 are parallel.

The illustrative peripheral device carrier 114 further comprises two side portions or side walls 204 and 206 that couple to the top wall 200 and bottom wall 202. Each side wall 204, 206 has a height “H”, the side walls 204, 206 are parallel to each other, and in the illustrative embodiments of FIG. 2 the side walls 204, 206 are perpendicular to the top wall 200 and bottom wall 202. The top wall 200, bottom wall 202 and two side walls 204, 206 define an internal volume 208 within which a peripheral device is mechanically coupled. In accordance with at least some embodiments, the peripheral device carrier 114 also comprises one or more tabs 210 which enable coupling of the peripheral device carrier 114 at least partially within the internal volume defined by the base portion 108 (FIG. 1). In particular, the peripheral device carrier 114 may be coupled within the portable computer system 100 by the use of fasteners installed through the apertures 212 of the tabs 210.

As illustrated in FIG. 2, the peripheral device carrier 114 in accordance with at least some embodiments defines a rectangular cross-section. The length L, width W and height H which define the rectangular cross-section may be selected based on the particular peripheral device to be placed within the peripheral device carrier 114. For example, the peripheral device mounted within the peripheral device carrier 114 may be a hard disk drive 214 as illustrated in FIG. 2. The hard disk drive 214 may have an internal 3.5 inch disk, and thus the length L, width W and height H may be selected to accommodate the mounting frame surrounding the 3.5 inch disk. In some embodiments, the peripheral device may couple within the internal volume 208 defined by the peripheral device carrier 114 by way of fasteners coupled through aperture 216 through the side wall 206 to corresponding threaded apertures 218 on the peripheral device. Corresponding apertures through the side wall 204 may also be present, but are not visible in the perspective view of FIG. 2.

Still referring to FIG. 2, in accordance with at least some embodiments the peripheral device carrier is formed from an extrusion process (discussed more below with respect to FIG. 3), and thus the peripheral device carrier 114 has open ends, where only open end 240 is visible in FIG. 2, but where the second open end is proximate in FIG. 2 to the illustrative hard disk drive 214. Thus, the peripheral device to be installed within the internal volume 208 of the peripheral device carrier may be telescoped within the internal volume 208 through either open end, as illustrated by line 230.

In order to provide protection against compressive forces for a peripheral device within the peripheral device carrier 114, in accordance with at least some embodiments the peripheral device carrier is constructed of an aluminum alloy, such as a 6061 or 6063 aluminum alloys. Such alloys of aluminum may also be referred to a “6000 grade” aluminum, “extrusion grade” aluminum and/or “aircraft grade” aluminum. In the length L, and width W ranges suitable for installing an illustrative 3.5 inch hard disk drive within the peripheral device carrier 114, the thickness “T” of the aluminum may be 0.7 milli-meters (mm) or greater, and in some cases 1.0 mm provides a good balance of protection against compressive forces for the peripheral, cost and weight.

In accordance with at least some embodiments, the overall form of the peripheral device carrier 114 is created in an extrusion process. FIG. 3 illustrates such an extrusion process. In particular, the 6000 grade aluminum alloys have material properties that make them particularly suited for extrusion into particular forms. In some cases the aluminum is heated to a molten state, and then forced or drawn through a die 300. The molten aluminum takes the cross-sectional shape defined by the die 300, and in this case the cross-sectional is a quadrilateral, and more particularly rectangular. Once the overall form is created by the extrusion process, the peripheral device carrier 114 may be cut and/or milled along dashed lines 302 into its final shape. In creating overall form of the peripheral device carrier in an extrusion process, the top wall, bottom wall and side walls are simultaneously formed. Moreover, because of the extrusion process, considered in cross-section the peripheral device carrier 114 is seamless. That is, there are neither butt-spliced sections welded together (butt-welds) nor overlapped sections tacked or continuously welded. The seamless quality of the peripheral device carrier 114 may increase resistance to deflection caused by applied compressive forces.

While extrusion is particularly suited to creation of the peripheral device carrier 114 of the various embodiments, other materials, and other forming mechanisms, may be equivalently used. For example, depending on the material and possible advances in injection molding of metallic materials (such as aluminum or magnesium), the peripheral device carrier 114 may be formed in whole or in part by injection molding (e.g., using a slip form).

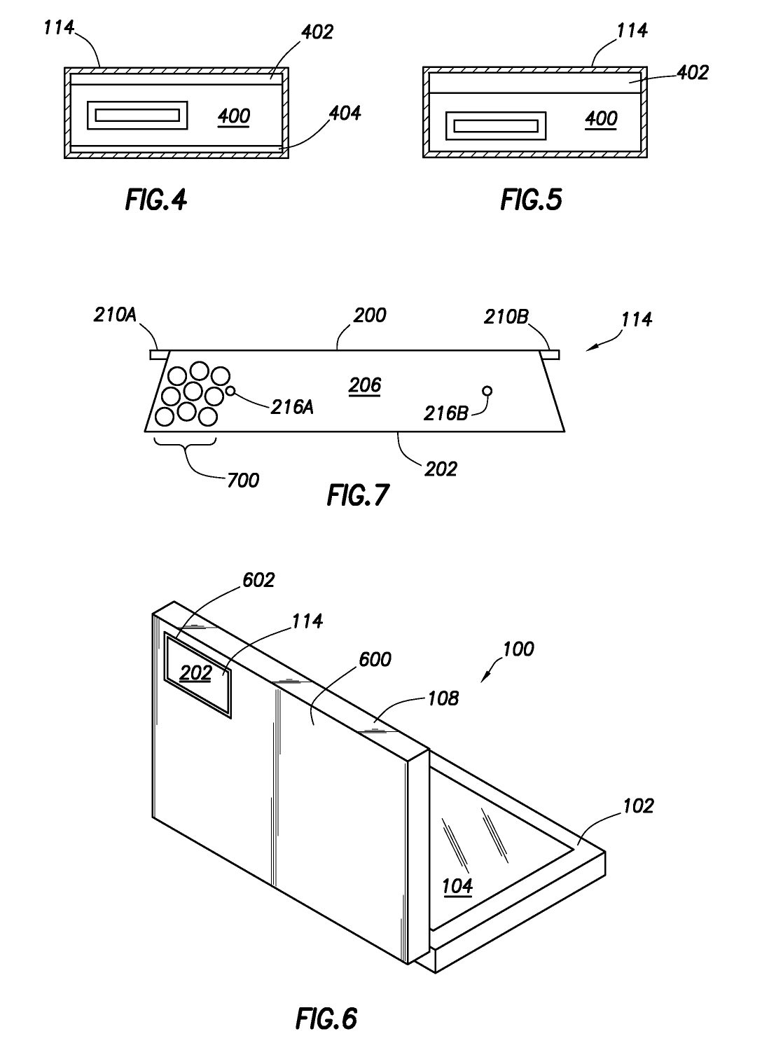

The precise internal dimensions are, as discussed above, controlled to some extend by the outside dimensions of the peripheral device to be telescoped within and coupled to the peripheral device carrier. However, the outside dimensions of the peripheral device only relate to the lower end dimensions, and the peripheral device carrier 114 dimensions may be increased for a variety of reasons. For example, FIG. 4 shows an elevational end-view of the peripheral device carrier 114 with a peripheral device 400 mounted within the internal volume. While the width of the peripheral device carrier 114 is selected such that the peripheral device 400 can be mechanically mounted in place, the height of the peripheral device carrier 114 in the illustration of FIG. 4 is selected to allow clearance both above and below the peripheral device. In particular, the embodiments of FIG. 4 have a clearance space 402 above the peripheral device 400, and a clearance space 404 below the peripheral device 400. The reasons for such clearance spaces may be many. In some cases, the clearance spaces 402 and 404 may enable airflow across the peripheral device for heat transfer purposes. In yet still other cases, the clearance spaces 400, 402 may provide room for deflection of the top wall or bottom wall to further protect against damage to the peripheral device 400 caused by compressive forced applied to the portable computer system 100.

FIG. 5 illustrates yet still further embodiments where the peripheral device 400 has a clearance 402, yet the peripheral device contacts the peripheral device carrier 114 on the bottom surface. Here again, the reasons for the illustrative arrangement of FIG. 5 may be many. The clearance space 402 may provide both space above the peripheral device for protection against deflection caused by compressive forces, and an air flow space for heat transfer. The peripheral device contacting the bottom wall of the peripheral device carrier 114 may be based on a conductive heat transfer requirement for operation of the peripheral device 400.

FIG. 6 illustrates yet still further embodiments. In particular, FIG. 6 illustrates a perspective view of the portable computer system 100 where a portion of the base portion 108 is visible, and likewise a portion of the screen portion 102 and display device 104 are visible. Base portion 108 defines a bottom outer surface 600 which is opposite that of surface 112 (FIG. 1, not visible in FIG. 6). While in some cases the peripheral device carrier 114 resides fully within the internal volume defined by the base portion 108, in the embodiments of FIG. 6 the bottom outer surface 600 has an aperture 602 through which the bottom wall 202 of the peripheral device carrier 114 is visible. In some embodiments, the peripheral device carrier 114 (and peripheral device mounted therein) is installed through the aperture 602. In other cases, the peripheral device carrier 114 is installed in other ways, yet the bottom wall 202 is still visible through the aperture 602. In accordance with at least some embodiments, the outer portion of the bottom wall 202 of the peripheral device carrier 114 is flush with the bottom outer surface 600. In embodiments where the bottom wall 202 is flush with the bottom outer surface 600, the bottom wall 202 may further comprise a decorative outer surface (such as by painting). Enabling the bottom wall 202 of the peripheral device carrier 114 to be mounted flush with the bottom outer surface 600 may enable reducing the thickness of the base portion 108 of the portable computer system 110 beyond that achievable if the peripheral device carrier 114 resides wholly within the volume defined by the base portion 108.

Finally, FIG. 7 shows an elevational side view in accordance with at least some embodiments. In particular, FIG. 7 illustrates that while in some embodiments the peripheral device carrier 114 may define a rectangular cross-section substantially perpendicular to the axis through which the peripheral devices are telescoped within the internal volume, the peripheral device carrier 114 need not have a rectangular cross-section along its length. FIG. 7 illustrates the bottom wall 202 having a larger length than the top wall 200, even taking into account tabs 210. Other shapes, viewed along the length of the peripheral device carrier 114, may be equivalently used. Moreover, FIG. 7 illustrates that the walls of the peripheral device carrier 114 need not be solid. In particular, the side wall 206 in FIG. 7 is shown to have not only the apertures 216 through which fasteners couple to a peripheral device within the internal volume, by may also comprise apertures 700. Though apertures 700 are shown on the side wall 206, such apertures 700 may reside in any wall of the peripheral device 114. The apertures may service many purposes. For example, the apertures may remove aluminum from the overall peripheral device carrier 114, and thus may make the carrier 114 lighter where weight is of concern. Moreover, the apertures may be strategically placed to improve air flow, possibly for heat transfer purposes, across the peripheral device. In some cases apertures 700 may have diameters of 2 mm to 3 mm, and may have 5 mm to 6 mm pitch (spacing). Using apertures 700 of the illustrative sizes may still maintain sufficient strength of the overall peripheral device carrier 114, while also meeting any other goal associated with use of apertures 700.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system comprising:
a screen portion with a display device viewable on one surface of the screen portion;
a base portion hinged to the screen portion, the base portion has a keyboard disposed on a first outer surface of the base portion, and the base portion defines an internal volume;
a peripheral device carrier mounted at least partially within the internal volume, the peripheral device carrier comprising:
a top wall and a bottom wall coupled by two side walls, the walls define a volume with a quadrilateral cross-section;
said walls comprise a metallic material, and said walls are seamless along the quadrilateral cross-section; and
a peripheral device mechanically coupled at least partially within the volume defined by the walls.

2. The system of claim 1 wherein the peripheral is a hard disk drive.

3. The system of claim 1 wherein the cross-section is rectangular.

4. The system of claim 1 further comprising:
the base portion defines a second outer surface opposite the first outer surface;
an aperture through the second outer surface; and
the bottom wall of the peripheral device carrier disposed within the aperture and substantially flush with the second outer surface.

5. The system of claim 1 wherein the walls of the peripheral device carrier are simultaneously formed in an extrusion process.

6. The system of claim 1 wherein the peripheral device carrier metallic material is 6000 grade aluminum.

7. The system of claim 1 wherein each wall has a thickness of 0.7 milli-meters (mm) or greater.

8. The system of claim 7 wherein each wall has a thickness of 1.0 mm.

9. A hard drive carrier comprising:
a top portion that defines a length, width, and a first plane;
a bottom portion that defines a second plane, parallel to the first plane;
a first side portion parallel to a second side portion, and the side portions perpendicular to and coupled to the top and bottom portions;
said top, bottom and side portions define a volume with a rectangular cross-section, and wherein the long dimension of the rectangular cross-section is configured to accept a hard drive telescoped within the volume;
said top, bottom and side portions made of an aluminum alloy, and said portions are seamless along the rectangular cross-section; and
at least one tab that extends from the hard drive carrier, the tab configured to couple the hard drive carrier within a computer system.

10. The hard drive carrier of claim 9 wherein the aluminum alloy is 6000 grade aluminum alloy.

11. The hard drive carrier of claim 9 wherein each portion has a thickness of 0.7 milli-meters (mm) or greater.

12. The hard drive carrier of claim 11 wherein each portion has a thickness of 1.0 mm.

13. The hard drive carrier of claim 9 wherein the short dimension of the rectangular cross-section is configured to accept a hard drive telescoped within the volume with clearance for air movement.

14. The hard drive carrier of claim 9 further comprising a first open end and a second open end, and wherein the ends are configured such that the hard drive can be telescoped to be within the volume through the first open and, and can be telescoped to be within the volume through the second open end.

15. The system of claim 9 wherein the top, bottom, first side and second side portions are simultaneously formed in an extrusion process.
